(19) United States
(12) Patent Application Publication
(10) Pub. No.: US 2006/0132030 A1
(43) Pub. Date: Jun. 22, 2006

(54) Display element stress free at the critical layer

(76) Inventors: Zhanjun Gao, Rochester, NY (US); Edward P. Furlani, Lancaster, NY (US)

Correspondence Address: Paul A. Leipold;Patent Legal Staff, Eastman Kodak Company, 343 State Street, Rochester, NY, 14650-2201, US

(21) Appl. No.: 11/022,126

(22) Filed: Dec. 22, 2004

(51) Int. Cl. H05B 33/02; H05B 33/00

(52) U.S. Cl. 313/511; 313/512; 313/506

(57) ABSTRACT

The invention relates to a display device, and more particularly a flexible display device comprising display component layers and display substrate such that the display remains substantially flat throughout the operating temperatures. The invention further relates a display device, and more particularly a flexible display device comprising display component layers and display substrate such that the stress in at least one layer of the light-emitting module in the display is substantially zero throughout the operating temperature range. These and other objects of the invention are accomplished by providing a flexible display, comprising at least one planar flexible substrate, at least one flexible light-emitting module deposited on the flexible substrate, the light-emitting module including at least one light-emitting layer, an anode, a cathode, and at least one top flexible superstrate on the opposite side of said display from said planar flexible substrate wherein the display is thermoelastically balanced in such a way that the display is always substantially flat, and the stress in at least one layer of the light-emitting module is substantially zero throughout the operating temperature range.

### FIELD OF THE INVENTION

This invention relates in general to a display device, and more particularly to a flexible organic light-emitting diode (OLED) and liquid crystal displays (LCD) devices comprising properly selected layers so that the display remains flat, and the thermal stress in the display can be reduced to avoid failure.

### BACKGROUND OF THE INVENTION

Most of commercial displays devices, for example, liquid crystal displays (LCD), or solid-state organic light-emitting diode (OLED) are rigid. LCD comprise two plane substrates, commonly fabricated by a rigid glass material, and a layer of a liquid crystal material or other imaging layer, and arranged in-between said substrates. The glass substrates are separated from each other by equally sized spacers being positioned between the substrates, thereby creating a more or less uniform gap between the substrates. Further, electrode means for creating an electric field over the liquid crystal material are provided and the substrate assembly is then placed between crossed polarizers to create a display. Thereby, optical changes in the liquid crystal display may be created by applying a voltage to the electrode means, whereby the optical properties of the liquid crystal material disposed between the electrodes is alterable.

In recent years, scientists and engineers have been enticed by the vision of flexible displays. A flexible display is defined in this disclosure as a flat-panel display using thin, flexible substrate, which can be bent to a radius of curvature of a few centimeters or less without loss of functionality. Flexible displays are considered to be more attractive than conventional rigid displays. They allow more freedom in design, promise smaller and more rugged devices. On the other hands, under bending moments, the rigid display tends to lose its image over a large area, due to the fact that the gap between the substrates changes, thereby causing the liquid crystal and OLED materials to flow away from the bending area, resulting in a changed crystal layer thickness. Consequently, displays utilizing glass substrates are less suitable, when a more flexible or even bendable display is desired.

Another advantage of using flexible substrates is that a plurality of display devices can be manufactured simultaneously by means of continuous web processing such as, for example, reel-to-reel processing. The manufacture of one or more display devices by laminating (large) substrates is alternatively possible. Dependent on the width of the reels used and the length and width of a reel of (substrate) material, a great many separate (display) cells or (in the case of “plastic electronics”) separate (semi-) products can be made in these processes. Such processes are therefore very attractive for bulk manufacture of said display devices and (semi-) products.

Some efforts have been made in the field of exchanging the above described glass substrates with substrates of a less fragile material, such as plastic. Plastic substrates provide for lighter and less fragile displays. One display using plastic substrates are described in the patent document U.S. Pat. No. 5,399,390. However, the natural flexibility of the plastic substrates presents problems, when trying to manufacture liquid crystal displays in a traditional manner. For example, the spacing between the substrates must be carefully monitored in order to provide a display with good picture reproduction. An aim in the production of prior art displays utilizing plastic substrate has therefore been to make the construction as rigid as possible, more or less imitating glass substrates. Thereby the flexible properties of the substrates have not been utilized to the full extent.

U.S. Pat. No. 6,710,841 discloses a liquid crystal display device having a first and a second substrate, being manufactured in a flexible material with a liquid crystal material disposed between the substrates. Together, the substrates form an array of cell enclosures, each containing an amount of liquid crystal. Further, each of said cell enclosures is separated from the adjacent enclosures by intermediate flexible parts. By creating a display from a flexible material and subdividing the display into a plurality of separate cell enclosures, the flexible, bendable display will bend along an intermediate part rather than through a liquid crystal filled cell, thereby maintaining the display quality, since the cells or “pixels” of the display are left intact. U.S. Pat. No. 6,710,841 only applies to displays for which the display module is stiff and therefore, has a high bending stiffness in comparison with the substrate. However, as disclosed in EP 1403687 A2, some displays have nano-dimension conductive layer and display layer. For such display, the intermediate part has a similar bending stiffness in comparison with the liquid crystal enclosures. Therefore, the enclosures experience bending similar to the intermediate part. The flexibility of the display is limited by the bending limitation of the display enclosures. EP 1403687 A2 also calls for two substrates that sandwich the display enclosures in the middle.

WO 02/067329 discloses a flexible display device comprising a flexible substrate, a number of display pixels arranged in a form of rows and columns on the surface of the substrate, a number of grooves in the surface of the substrate, each of which is formed in between adjacent two rows or columns of the display pixels, and connection lines for electrically interconnecting the plurality of display pixels, thereby providing flexibility to the display device and, at the same time, minimizing the propagation of mechanical stress caused when the display device is bent or rolled. A method of manufacturing the display device is also disclosed. However, the introduction of grooves to the substrate causes significant stress concentration in the grooves. This may lead to substrate fracture during manufacturing or usage.

Solid-state organic light-emitting diode (OLED) image display devices utilize current passing through thin films of organic material to generate light. The color of light emitted and the efficiency of the energy conversion from current to light are determined by the composition of the organic thin-film material. Different organic materials emit different colors of light.

From a structural perspective, OLED and other flexible display devices are essentially a multilayer stack of thin film laminates. These laminates can range in thickness from a few nanometers, to hundreds of microns. When these structures carry an electrical current, joule heating takes place, and there is a potential for deleterious structural stress due to the mismatch of thermal expansion coefficients from one layer to the next. The prior art has attempted to address the aforementioned drawbacks and disadvantages, but has achieved mixed results.

For example, in order to redistribute thermal stress, the use of a spacer layer between the thin film and a more rigid layer of a multilayer flexible electronic device has been devised. Although this technique is applied in U.S. Pat. Nos. 6,281,452B1 and 6,678,949 in order to minimize thermal stress, it is nonetheless characterized by drawbacks. This method is generally less than ideal, since it adds unnecessary thickness to a device that is required to be sufficiently thin. Additionally, such thickness restrictions hinder the possibility of employing additional layers that may be needed to minimize thermal stress.

U.S. Pat. No. 5,319,479 discloses a multilayer device, comprised of an electronic element, a plastic substrate, and a thin film, wherein the thermal deformation of the thin film is minimized by plastic substrate and the electronic element. This method has a distinct disadvantage in that it does not provide flexibility in adjusting the coefficient of thermal expansion and the thickness of the respective layers.

### PROBLEM TO BE SOLVED BY THE INVENTION

There remains a need for a more comprehensive method of eliminating thermally induced deformation and stress in multiplayer flexible display devices.

### SUMMARY OF THE INVENTION

It is an object of the invention to develop a display device, and more particularly a flexible display device comprising display component layers and display substrate such that the display remains substantially flat throughout the operating temperatures.

It is another object to develop a display device, and more particularly a flexible display device comprising display component layers and display substrate such that the stress in at least one layer of the light-emitting module in the display is substantially zero throughout the operating temperature range.

These and other objects of the invention are accomplished by providing a flexible display, comprising at least one planar flexible substrate, at least one flexible light-emitting module deposited on the flexible substrate, the light-emitting module including at least one light-emitting layer, an anode, a cathode, and at least one top flexible superstrate on the opposite side of said display from said planar flexible substrate wherein the display is thermoelastically balanced in such a way that the display is always substantially flat, and the stress in at least one layer of the light-emitting module is substantially zero throughout the operating temperature range.

### ADVANTAGEOUS EFFECT OF THE INVENTION

The invention provides a display device, and more particularly a flexible display device that remains substantially flat and the stress in at least one layer of the light-emitting module in the display is substantially zero throughout the operating temperatures. It is important for the display to remain flat for better viewing. Furthermore, since the stress in one layer of the light-emitting module is substantially zero throughout the operating temperature range, this layer can be chosen to be the most vulnerable layer in the light-emitting module to avoid stress-induced damage and failure of the display due to temperature changes.

### BRIEF DESCRIPTION OF THE DRAWINGS

FIG. 1 represents a section view of one embodiment of the present invention.

FIG. 2 represents a section view of a generic multi-layered material with the commonly used nomenclatures.

FIG. 3 represents a section view of an example of the present invention (symmetric).

FIG. 4. Stress in the OLED layer of the light-emitting module in the display layer shown in FIG. 3, under 20 C degree temperature change.

FIG. 5 represents a section view of another example of the present invention (asymmetric).

FIG. 6. Stress in the OLED layer of the light-emitting module in the display layer shown in FIG. 5, under 20 C degree temperature change.

FIG. 7. Curvature of the display shown in FIG. 5, under 20 C degree temperature change.

### DETAILED DESCRIPTION OF THE INVENTION

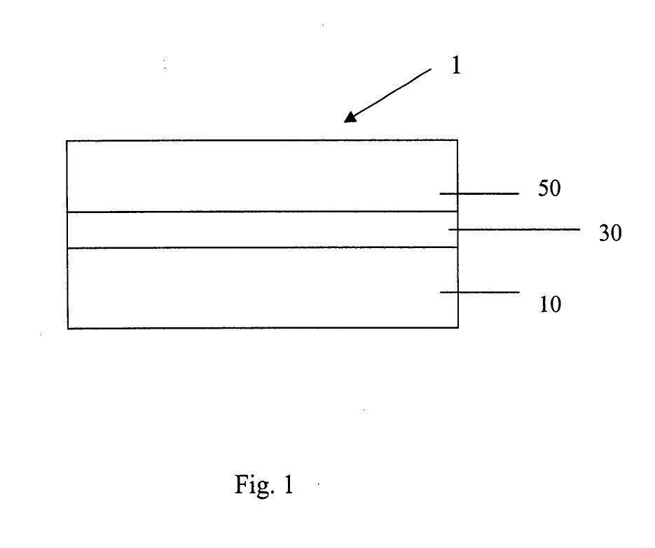

Referring to FIG. 1, embodiment 1 of the present invention consists of a substrate 10, a flexible light-emitting module 30 which includes light-emitting material, an anode, and a cathode (not shown), and a superstrate 50. These layers are described in detail below.

Note that the substrate may alternatively be located adjacent to the cathode, or the substrate may actually constitute the anode or cathode. The flexible light-emitting module may contain organic layers and other layers such as a hole-injecting layer, a hole-transporting layer, and electron-transporting layer. The total combined thickness of the organic layers is typically less than 500 nm as disclosed in U.S. Pat. No. 6,771,021.

Flexible displays are made of multilayered thin films. These film layers have different thickness, thermal/moisture expansion coefficients and thermal shrinkage behavior that results in deflection and bending stress due to temperature changes. The deflection and stress can affect the display image quality as well the reliability of the display components.

Referring to FIG. 1, flexible light-emitting module 30 is considered the critical layer for which we need to minimize the stress since it can sustain very minimal tensile or compression deformation/strain and stress. When the display 1 shown in FIG. 1 is under temperature change, since the layers in the display have different coefficient of thermal expansion, they tend to expand differently. However, the layers are bonded together and the final expansion of the display is a compromised position where layers may be under either compression or tension, depending on the values of the coefficients of thermal expansion. The thermal expansion of the display in FIG. 1 can also cause bending curvature. Such a curvature may not be desirable. The present invention calls for a display that contains layers with desired properties (thickness, coefficient of thermal expansion, Young's modulus) so that the display remains flat (without curvature). Furthermore, at least one layer of the light-emitting module is substantially stress free. The stress free layer is often taken as the critical layer which is most vulnerable to stress induced damage. It may be the light-emitting layer or the anode layer. Such a concept is explained in detail using related mathematical formulation below.

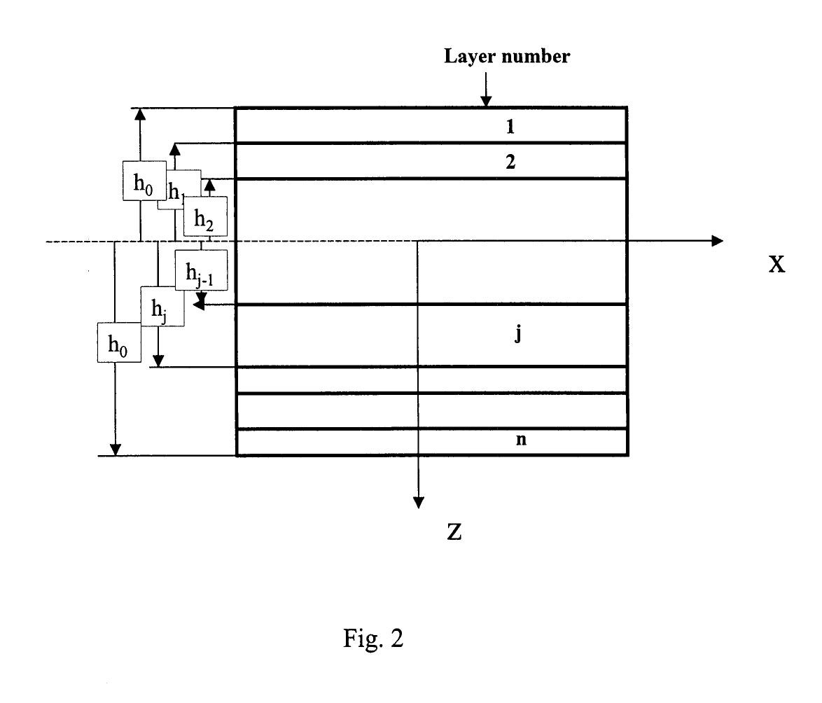

The stress in the laminates due to temperature change is denoted by {σ^{T}}. It is determined that the stress in the j-th layer of a n-layer display is given in the form below, see FIG. 2,

$${\{ \begin{matrix}{σ}_{x}^{T} \\ {σ}_{y}^{T} \\ {σ}_{xy}^{T}\end{matrix} \}}_{j} = [ Q ] [ \{ \begin{matrix}{ɛ}_{x}^{0} \\ {ɛ}_{y}^{0} \\ {ɛ}_{xy}^{0}\end{matrix} \} + {h}_{k} \{ \begin{matrix}{k}_{x} \\ {k}_{y} \\ {k}_{xy}\end{matrix} \} - Δ T {\{ \begin{matrix}{α}_{x} \\ {α}_{y} \\ {α}_{xy}\end{matrix} \}}_{j} ] \qquad ( 1 )$$

where

{σ^{T}}ⱼ=Thermal stress in the j-th layer in the n-layer laminate,

{ε⁰}=Mid-plane strain,

{k}=Plate curvature,

{α}ⱼ=Coefficients of thermal expansion in the j-th layer in the n-layer laminate,

ΔT=Temperature change,

[Q]=Material property matrix, and

hⱼ=Distance of the j-th layer to the neutral plane where the normal stress is zero. The expression of material property matrix, [Q], is given in detail in “Analysis and Performance of Fiber Composites” by B. D Agarwal and L. J. Broutman, 2nd Edition, John Wiley & Sons, Inc., New York, 1990.

The mid-plane strain and plate curvature are determined from the following equations

$$\begin{matrix}[ A ] \{ \begin{matrix}{ɛ}_{x}^{0} \\ {ɛ}_{y}^{0} \\ {ɛ}_{xy}^{0}\end{matrix} \} + [ B ] \{ \begin{matrix}{k}_{x} \\ {k}_{y} \\ {k}_{xy}\end{matrix} \} = \{ \begin{matrix}{N}_{x}^{T} \\ {N}_{y}^{T} \\ {N}_{xy}^{T}\end{matrix} \} & ( 2 ) \\ [ B ] \{ \begin{matrix}{ɛ}_{x}^{0} \\ {ɛ}_{y}^{0} \\ {ɛ}_{xy}^{0}\end{matrix} \} + [ D ] \{ \begin{matrix}{k}_{x} \\ {k}_{y} \\ {k}_{xy}\end{matrix} \} = \{ \begin{matrix}{M}_{x}^{T} \\ {M}_{y}^{T} \\ {M}_{xy}^{T}\end{matrix} \} & ( 3 )\end{matrix}$$

where the expression of material property matrix, [A], [B] and [D] are given in details in “Analysis and Performance of Fiber Composites” by B. D Agarwal and L. J. Broutman, 2nd Edition, John Wiley & Sons, Inc., New York, 1990. The moment [M^{T}] is the moments caused by temperature change, the force [N^{T}] is the in plane forces caused by temperature change, and

$$\{ \begin{matrix}{N}_{x}^{T} \\ {N}_{y}^{T} \\ {N}_{xy}^{T}\end{matrix} \} = Δ T {\sum }_{j = 1}^{n} {[ Q ]}_{j} {\{ \begin{matrix}{α}_{x} \\ {α}_{y} \\ {α}_{xy}\end{matrix} \}}_{j} ( {h}_{j} - {h}_{j - 1} ) \\ \{ \begin{matrix}{M}_{x}^{T} \\ {M}_{y}^{T} \\ {M}_{xy}^{T}\end{matrix} \} = \frac{1}{2} Δ T {\sum }_{j = 1}^{n} {[ Q ]}_{j} {\{ \begin{matrix}{α}_{x} \\ {α}_{y} \\ {α}_{xy}\end{matrix} \}}_{j} ( {h}_{j}^{2} - {h}_{j - 1}^{2} ) \qquad ( 4 )$$

where [Q]ⱼ is the material property matrix of the j-th layer of the laminate, given in details in “Analysis and Performance of Fiber Composites” by B. D Agarwal and L. J. Broutman, 2nd Edition, John Wiley & Sons, Inc., New York, 1990.

Equations (2) and (3) determine the mid-plane strain, {ε⁰}, and the plate curvature, {k} for known forces and moments due to temperature and moisture changes, [M^{T}],[N^{T}]. Equation (1) then yields the stress in any layer.

From Equations (2) and (3), we can solve for {ε⁰}, and the plate curvature, {k} as follows

$$\begin{matrix}\{ \begin{matrix}{ɛ}_{x}^{0} \\ {ɛ}_{y}^{0} \\ {ɛ}_{xy}^{0}\end{matrix} \} + {[ A ]}^{- 1} [ B ] \{ \begin{matrix}{k}_{x} \\ {k}_{y} \\ {k}_{xy}\end{matrix} \} = {[ A ]}^{- 1} \{ \begin{matrix}{N}_{x}^{T} \\ {N}_{y}^{T} \\ {N}_{xy}^{T}\end{matrix} \} & ( 5 ) \\ \{ \begin{matrix}{ɛ}_{x}^{0} \\ {ɛ}_{y}^{0} \\ {ɛ}_{xy}^{0}\end{matrix} \} + {[ B ]}^{- 1} [ D ] \{ \begin{matrix}{k}_{x} \\ {k}_{y} \\ {k}_{xy}\end{matrix} \} = {[ B ]}^{- 1} \{ \begin{matrix}{M}_{x}^{T} \\ {M}_{y}^{T} \\ {M}_{xy}^{T}\end{matrix} \} & ( 6 ) \\ \{ \begin{matrix}{k}_{x} \\ {k}_{y} \\ {k}_{xy}\end{matrix} \} = \{ {[ A ]}^{- 1} [ B ] - {[ B ]}^{- 1} [ D ] \} \{ {[ A ]}^{- 1} \{ \begin{matrix}{N}_{x}^{T} \\ {N}_{y}^{T} \\ {N}_{xy}^{T}\end{matrix} \} - {[ B ]}^{- 1} \{ \begin{matrix}{M}_{x}^{T} \\ {M}_{y}^{T} \\ {M}_{xy}^{T}\end{matrix} \} \} & ( 7 )\end{matrix}$$

Similarly,

$$\begin{matrix} {[ B ]}^{- 1} [ A ] \{ \begin{matrix}{ɛ}_{x}^{0} \\ {ɛ}_{y}^{0} \\ {ɛ}_{xy}^{0}\end{matrix} \} + \{ \begin{matrix}{k}_{x} \\ {k}_{y} \\ {k}_{xy}\end{matrix} \} = {[ B ]}^{- 1} \{ \begin{matrix}{N}_{x}^{T} \\ {N}_{y}^{T} \\ {N}_{xy}^{T}\end{matrix} \} & ( 8 ) \\ {[ D ]}^{- 1} [ B ] \{ \begin{matrix}{ɛ}_{x}^{0} \\ {ɛ}_{y}^{0} \\ {ɛ}_{xy}^{0}\end{matrix} \} + \{ \begin{matrix}{k}_{x} \\ {k}_{y} \\ {k}_{xy}\end{matrix} \} = {[ D ]}^{- 1} \{ \begin{matrix}{M}_{x}^{T} \\ {M}_{y}^{T} \\ {M}_{xy}^{T}\end{matrix} \} & ( 9 ) \\ \{ \begin{matrix}{ɛ}_{x}^{0} \\ {ɛ}_{y}^{0} \\ {ɛ}_{xy}^{0}\end{matrix} \} = {\{ {[ B ]}^{- 1} [ A ] - {[ D ]}^{- 1} [ B ] \}}^{- 1} \{ {[ B ]}^{- 1} \{ \begin{matrix}{N}_{x}^{T} \\ {N}_{y}^{T} \\ {N}_{xy}^{T}\end{matrix} \} - {[ D ]}^{- 1} \{ \begin{matrix}{M}_{x}^{T} \\ {M}_{y}^{T} \\ {M}_{xy}^{T}\end{matrix} \} \} & ( 10 )\end{matrix}$$

Therefore, to make the display flat, the curvature needs to be zero, i.e.,

$$\{ {[ A ]}^{- 1} [ B ] - {[ B ]}^{- 1} [ D ] \} \{ {[ A ]}^{- 1} \{ \begin{matrix}{N}_{x}^{T} \\ {N}_{y}^{T} \\ {N}_{xy}^{T}\end{matrix} \} - {[ B ]}^{- 1} \{ \begin{matrix}{M}_{x}^{T} \\ {M}_{y}^{T} \\ {M}_{xy}^{T}\end{matrix} \} \} = \{ \begin{matrix}{k}_{x}^{0} \\ {k}_{y}^{0} \\ {k}_{xy}^{0}\end{matrix} \} = \{ \begin{matrix}0 \\ 0 \\ 0\end{matrix} \} \qquad ( 11 )$$

To made the stress zero in a critical layer, we needs

$${\{ {[ B ]}^{- 1} [ A ] - {[ D ]}^{- 1} [ B ] \}}^{- 1} \{ {[ B ]}^{- 1} \{ \begin{matrix}{N}_{x}^{T} \\ {N}_{y}^{T} \\ {N}_{xy}^{T}\end{matrix} \} - {[ D ]}^{- 1} \{ \begin{matrix}{M}_{x}^{T} \\ {M}_{y}^{T} \\ {M}_{xy}^{T}\end{matrix} \} \} = \{ \begin{matrix}{ɛ}_{x}^{0} \\ {ɛ}_{y}^{0} \\ {ɛ}_{xy}^{0}\end{matrix} \} = Δ T {\{ \begin{matrix}{α}_{x} \\ {α}_{y} \\ {α}_{xy}\end{matrix} \}}_{j} \qquad ( 12 )$$

Hence, the problem is to determine properties (modulus, coefficient of thermal expansion, and thickness) of the layers in the display so that conditions (11) and (12) are both satisfied. Actual examples are included below.

It is clear from Equations (11) and (12) that the stress in each layer is uniquely determined from the properties (modulus, coefficient of thermal expansion), and dimension of each layer. Therefore, we can optimize or reduce the stress in a layer that we deem critical to maintain the integrity of the display. The critical layer may include key layer such as conductive layer, light-emitting layer. Furthermore, we can also keep the display flat at the same time. For example, to minimize the stress in the j-th layer which is critical layer, we need to select the properties (modulus, thickness, coefficient of thermal expansion) of individual layers so that so that condition (11) is satisfied. Actual examples are included below.

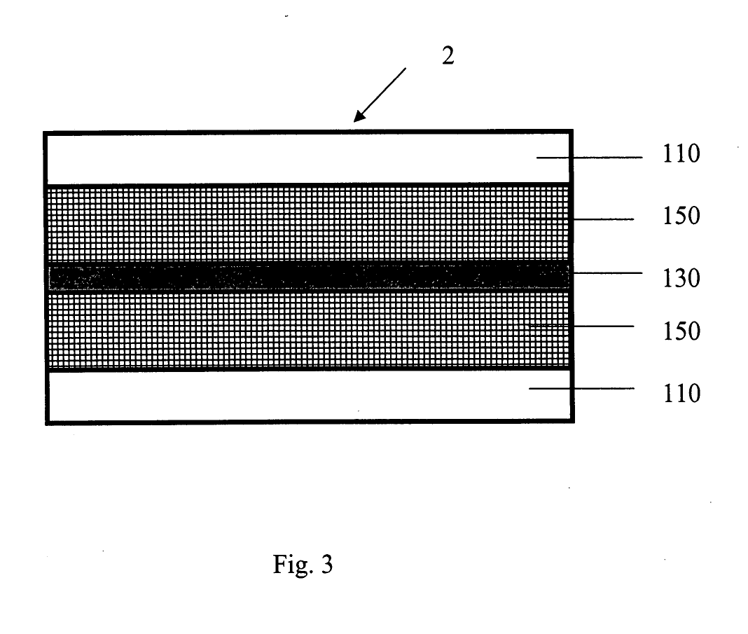

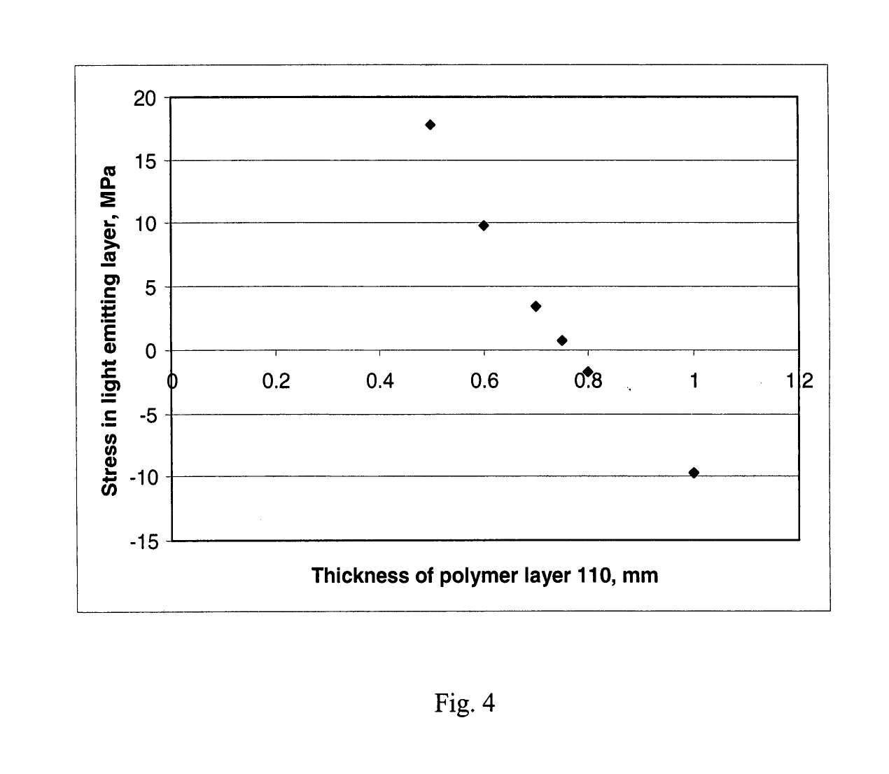

One way to find a suitable solution of the present invention is to use a symmetric structure. By doing so, the display has no curvature under temperature changes. We just need to select the layers and their properties so that the critical layer has thermal strain that match the thermal strain of the whole laminate. One example of such a symmetric display structure 2 is shown in FIG. 3, where the light-emitting module 130 is in the center, flanked by two PET layers 150 and then by two other polymer layers 110. In this example, the substrate consists of two layers—PET layer 150 and other polymer layer 110. The superstrate also consists of two layers—top PET layer 150 and top other polymer layer 110. The light-emitting module 130 has a thickness of 4 μm, Young's modulus of 4 GPa, coefficient of thermal expansion 24.8×10⁻⁶/C. The PET layers 150 have a thickness of 5000 μm, a thermal coefficient of expansion of 70×10⁻⁶/C and a Young's Modulus of 4 GPa. The polymer layer 110 has a thermal coefficient of expansion of 10×10⁻⁶/C and a Young's Modulus of 8 GPa. FIG. 4 shows that when the thickness of the polymer layer 110 is changed, the stress of the critical layer (in this case, the light-emitting layer) can be minimized to zero. Of course, since the layer structure of the display is symmetric, it remains flat as well.

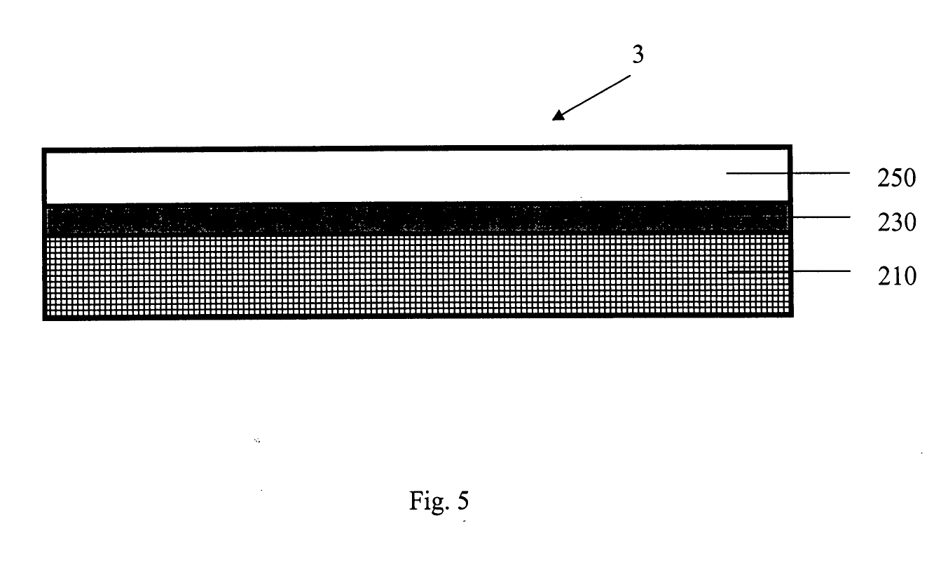

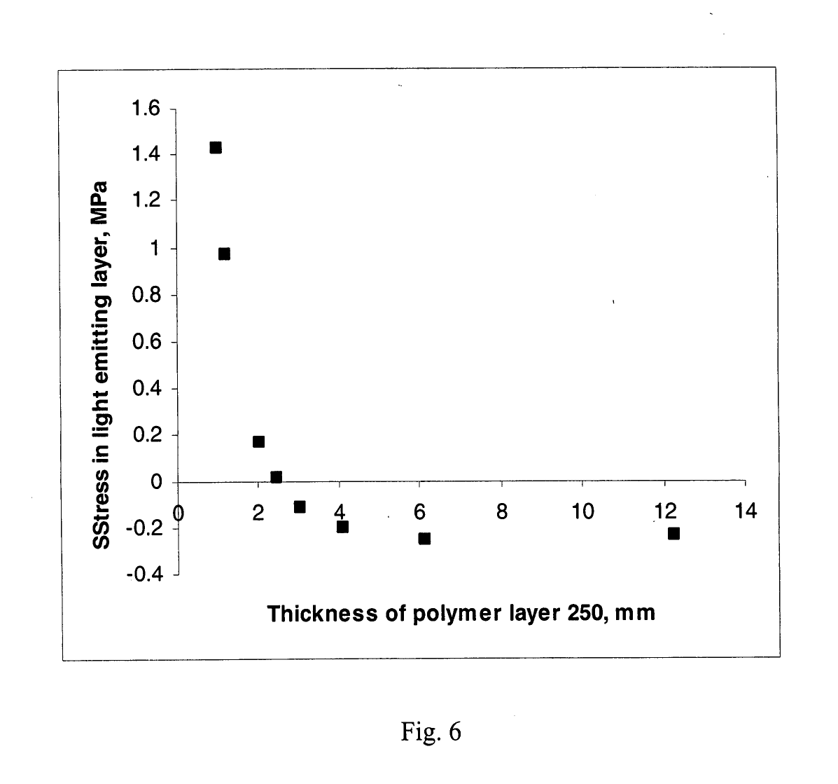

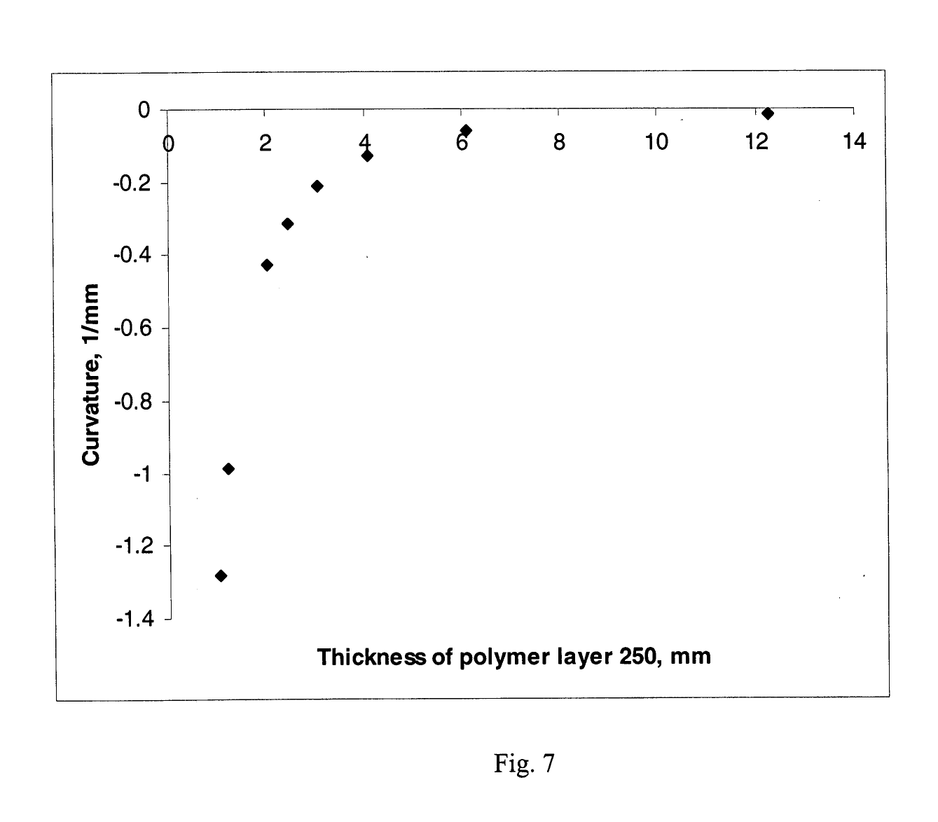

Another example is shown in FIG. 5, where the asymmetric display consists of three layers, the aluminum substrate 210, light-emitting module 230 and polymer superstrate 250. The light-emitting module 230 has a thickness of 2 μm, Young's modulus of 4 GPa, coefficient of thermal expansion 24.8×10⁻⁶/C. The aluminum substrate 210 have a thickness of 500 μm, a thermal coefficient of expansion of 23×10⁻⁶/C and a Young's Modulus of 70 GPa. The polymer superstrate 250 has a thermal coefficient of expansion of 90×10⁻⁶/C and a Young's Modulus of 8 GPa. FIGS. 6 and 7 show that when the thickness of the polymer superstrate 250 is between 4 mm to 12 mm, both stress in the light-emitting module and the curvature of the display are small under a temperature change of 20 C.

The present invention can be employed in most flexible OLED device configurations. These include very simple structures comprising a single anode and cathode to more complex devices, such as passive matrix displays comprised of orthogonal arrays of anodes and cathodes to form light-emitting elements, and active-matrix displays where each light-emitting element is controlled independently, for example, with thin film transistors (TFTs).

The anode and cathode of the OLED are connected to a voltage/current source through electrical conductors. The OLED is operated by applying a potential between the anode and cathode such that the anode is at a more positive potential than the cathode. Holes are injected into the organic light emitting-layer from the anode and electrons are injected into the organic light emitting-layer at the anode. Enhanced device stability can sometimes be achieved when the OLED is operated in an AC mode where, for some time period in the cycle, the potential bias is reversed and no current flows. An example of an AC-driven OLED is described in U.S. Pat. No. 5,552,678.

Substrate and Superstrate

The flexible display device of this invention is typically provided over a supporting substrate 10, FIG. 1, where either the cathode or anode can be in contact with the substrate. The electrode in contact with the substrate is conveniently referred to as the bottom electrode. Conventionally, the bottom electrode is the cathod, but this invention is not limited to that configuration. The substrate 10 can either be transmissive or opaque. In the case wherein the substrate is transmissive, a reflective or light absorbing layer is used to reflect the light through the cover or to absorb the light, thereby improving the contrast of the display. The superstrate 50, FIG. 1, is utilized to protect the light-emitting module and to balance the thermal expansion of the display. The superstrate should be transmissive. In general both substrate and superstrate can consist multiple materials in multiple layers. The substrate can be thin metal material (such as aluminum foil), flexible plastic film or combination of them. The superstrate can be any flexible self-supporting plastic film that supports the thin conductive metallic film.

“Plastic” as a whole or a layer of the substrate 10 or superstrate 50 means a high polymer, usually made from polymeric synthetic resins, which may be combined with other ingredients, such as curatives, fillers, reinforcing agents, colorants, and plasticizers. Plastic includes thermoplastic materials and thermosetting materials.

The flexible plastic film must have sufficient thickness and mechanical integrity so as to be self-supporting, yet should not be so thick as to be rigid. Typically, the flexible plastic film is the thickest layer of the composite film in thickness. Consequently, the film determines to a large extent the mechanical and thermal stability of the fully structured composite film.

Another significant characteristic of the flexible plastic film material is its glass transition temperature (Tg). Tg is defined as the glass transition temperature at which plastic material will change from the glassy state to the rubbery state. It may comprise a range before the material may actually flow. Suitable materials for the flexible plastic film include thermoplastics of a relatively low glass transition temperature, for example up to 150° C., as well as materials of a higher glass transition temperature, for example, above 150° C. The choice of material for the flexible plastic film would depend on factors such as manufacturing process conditions, such as deposition temperature, and annealing temperature, as well as post-manufacturing conditions such as in a process line of a displays manufacturer. Certain of the plastic films discussed below can withstand higher processing temperatures of up to at least about 200° C., some up to 3000-350° C., without damage.

Typically, the flexible plastic film is polyethylene terephthalate (PET), polyethylene naphthalate (PEN), polyethersulfone (PES), polycarbonate (PC), polysulfone, a phenolic resin, an epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl (x-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA). Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic film is a cyclic polyolefin or a polyester. Various cyclic polyolefins are suitable for the flexible plastic film. Examples include Arton® made by Japan Synthetic Rubber Co., Tokyo, Japan; Zeanor T made by Zeon Chemicals L. P., Tokyo Japan; and Topas® made by Celanese A. G., Kronberg Germany. Arton is a poly(bis(cyclopentadiene)) condensate that is a film of a polymer. Alternatively, the flexible plastic film can be a polyester. A preferred polyester is an aromatic polyester such as Arylite. Although various examples of plastic films are set forth above, it should be appreciated that the film can also be formed from other materials such as glass and quartz.

The flexible plastic film can be reinforced with a hard coating. Typically, the hard coating is an acrylic coating. Such a hard coating typically has a thickness of from 1 to 15 microns, preferably from 2 to 4 microns and can be provided by free radical polymerization, initiated either thermally or by ultraviolet radiation, of an appropriate polymerizable material. Depending on the film, different hard coatings can be used. When the film is polyester or Arton, a particularly preferred hard coating is the coating known as “Lintec.” Lintec contains UV-cured polyester acrylate and colloidal silica. When deposited on Arton, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wis.

Light-Emitting Module

A typical structure for the light-emitting module consists at least one light-emitting layer, an anode, a cathode, and other layers such as a hole-injecting layer, a hole-transporting layer, and electron-transporting layer. The major layers of the light-emitting module are described in details below.

Anode

When LIGHT emission is viewed through anode, the anode should be transparent or substantially transparent to the emission of interest. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode. For applications where light emission is viewed only through the cathode electrode, the transmissive characteristics of anode are immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes. Optionally, anodes may be polished prior to application of other layers to reduce surface roughness so as to minimize shorts or enhance reflectivity.

Light-Emitting Layer (LEL)

As more fully described in U.S. Pat. Nos. 4,769,292 and 5,935,721, the light-emitting layer of the organic light-emitting module includes a luminescent or fluorescent material where electroluminescence is produced as a result of electron-hole pair recombination in this region. The light-emitting layer can be comprised of a single material, but more commonly consists of a host material doped with a guest compound or compounds where light emission comes primarily from the dopant and can be of any color. The host materials in the light-emitting layer can be an electron-transporting material, as defined below, a hole-transporting material, as defined above, or another material or combination of materials that support hole-electron recombination. The dopant is usually chosen from highly fluorescent dyes, but phosphorescent compounds, e.g., transition metal complexes as described in WO 98/55561, WO 00/18851, WO 00/57676, and WO 00/70655 are also useful. Dopants are typically coated as 0.01 to 10% by weight into the host material. Polymeric materials such as polyfluorenes and polyvinylarylenes (e.g., poly(p-phenylenevinylene), PPV) can also be used as the host material. In this case, small molecule dopants can be molecularly dispersed into the polymeric host, or the dopant could be added by copolymerizing a minor constituent into the host polymer.

An important relationship for choosing a dye as a dopant is a comparison of the bandgap potential which is defined as the energy difference between the highest occupied molecular orbital and the lowest unoccupied molecular orbital of the molecule. For efficient energy transfer from the host to the dopant molecule, a necessary condition is that the band gap of the dopant is smaller than that of the host material. For phosphorescent emitters it is also important that the host triplet energy level of the host be high enough to enable energy transfer from host to dopant.

Host and emitting molecules known to be of use include, but are not limited to, those disclosed in U.S. Pat. Nos. 4,768,292; 5,141,671; 5,150,006; 5,151,629; 5,405,709; 5,484,922; 5,593,788; 5,645,948; 5,683,823; 5,755,999; 5,928,802; 5,935,720; 5,935,721; and 6,020,078.

Metal complexes of 8-hydroxyquinoline (oxine) and similar derivatives constitute one class of useful host compounds capable of supporting electroluminescence. Illustrative of useful chelated oxinoid compounds are the following:

CO-1: Aluminum trisoxine [alias, tris(8-quinolinolato) aluminum(III)]

CO-2: Magnesium bisoxine [alias, bis(8-quinolinolato) magnesium(II)]

CO-3: Bis[benzo {f}-8-quinolinolato]zinc (II)

CO-4: Bis(2-methyl-8-quinolinolato)aluminum(III)-□-oxo-bis(2-methyl-8-quinolinolato) aluminum(III)

CO-5: Indium trisoxine [alias, tris(8-quinolinolato) indium]

CO-6: Aluminum tris(5-methyloxine) [alias, tris(5-methyl-8-quinolinolato) aluminum(III)]

CO-7: Lithium oxine [alias, (8-quinolinolato)lithium(I)]

CO-8: Gallium oxine [alias, tris(8-quinolinolato) gallium(III)]

CO-9: Zirconium oxine [alias, tetra(8-quinolinolato) zirconium(IV)]

Other classes of useful host materials include, but are not limited to: derivatives of anthracene, such as 9,10-di-(2-naphthyl) anthracene and derivatives thereof as described in U.S. Pat. No. 5,935,721, distyrylarylene derivatives as described in U.S. Pat. No. 5,121,029, and benzazole derivatives, for example, 2,2′,2″-(1,3,5-phenylene)tris[1-phenyl-1H-benzimidazole]. Carbazole derivatives are particularly useful hosts for phosphorescent emitters.

Useful fluorescent dopants include, but are not limited to, derivatives of anthracene, tetracene, xanthene, perylene, rubrene, coumarin, rhodamine, and quinacridone, dicyanomethylenepyran compounds, thiopyran compounds, polymethine compounds, pyrilium and thiapyrilium compounds, fluorene derivatives, periflanthene derivatives, indenoperylene derivatives, bis(azinyl)amine boron compounds, bis(azinyl) methane compounds, and carbostyryl compounds.

Cathode

When light emission is viewed solely through the anode, the cathode used in this invention can be comprised of nearly any conductive material. Desirable materials have good film-forming properties to ensure good contact with the underlying organic layer, promote electron injection at low voltage, and have good stability. Useful cathode materials often contain a low work function metal (<4.0 eV) or metal alloy. One preferred cathode material is comprised of a Mg:Ag alloy wherein the percentage of silver is in the range of 1 to 20%, as described in U.S. Pat. No. 4,885,221. Another suitable class of cathode materials includes bilayers comprising a thin electron-injection layer (EIL) in contact with the organic layer (e.g., ETL) which is capped with a thicker layer of a conductive metal. Here, the EIL preferably includes a low work function metal or metal salt, and if so, the thicker capping layer does not need to have a low work function. One such cathode is comprised of a thin layer of LiF followed by a thicker layer of Al as described in U.S. Pat. No. 5,677,572. Other useful cathode material sets include, but are not limited to, those disclosed in U.S. Pat. Nos. 5,059,861, 5,059,862, and 6,140,763.

When light emission is viewed through the cathode, the cathode must be transparent or nearly transparent. For such applications, metals must be thin or one must use transparent conductive oxides, or a combination of these materials. Optically transparent cathodes have been described in more detail in U.S. Pat. No. 4,885,211, U.S. Pat. No. 5,247,190, JP 3,234,963, U.S. Pat. No. 5,703,436, U.S. Pat. No. 5,608,287, U.S. Pat. No. 5,837,391, U.S. Pat. No. 5,677,572, U.S. Pat. No. 5,776,622, U.S. Pat. No. 5,776,623, U.S. Pat. No. 5,714,838, U.S. Pat. No. 5,969,474, U.S. Pat. No. 5,739,545, U.S. Pat. No. 5,981,306, U.S. Pat. No. 6,137,223, U.S. Pat. No. 6,140,763, U.S. Pat. No. 6,172,459, EP 1 076 368, U.S. Pat. No. 6,278,236, and U.S. Pat. No. 6,284,393. Cathode materials are typically deposited by evaporation, sputtering, or chemical vapor deposition. When needed, patterning can be achieved through many well known methods including, but not limited to, through-mask deposition, integral shadow masking, for example, as described in U.S. Pat. No. 5,276,380 and EP 0 732 868, laser ablation, and selective chemical vapor deposition.

Deposition of Light-Emitting Layers

The organic materials mentioned above are suitably deposited through a vapor-phase method such as sublimation, but can be deposited from a fluid, for example, from a solvent with an optional binder to improve film formation. If the material is a polymer, solvent deposition is useful but other methods can be used, such as sputtering or thermal transfer from a donor sheet. The material to be deposited by sublimation can be vaporized from a sublimator “boat” often comprised of a tantalum material, e.g., as described in U.S. Pat. No. 6,237,529, or can be first coated onto a donor sheet and then sublimed in closer proximity to the film. Layers with a mixture of materials can utilize separate sublimator boats or the materials can be pre-mixed and coated from a single boat or donor sheet. Patterned deposition can be achieved using shadow masks, integral shadow masks (U.S. Pat. No. 5,294,870), spatially-defined thermal dye transfer from a donor sheet (U.S. Pat. Nos. 5,688,551, 5,851,709 and 6,066,357) and inkjet method (U.S. Pat. No. 6,066,357).

Encapsulation

Most OLED and LCD devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOx, Teflon, and alternating inorganic/polymeric layers are known in the art for encapsulation.

Optical Optimization

OLED devices of this invention can employ various well-known optical effects in order to enhance its properties if desired. This includes optimizing layer thicknesses to yield maximum light transmission, providing dielectric mirror structures, replacing reflective electrodes with light-absorbing electrodes, providing anti glare or anti-reflection coatings over the display, providing a polarizing medium over the display, or providing colored, neutral density, or color conversion filters over the display. Filters, polarizers, and anti-glare or anti-reflection coatings may be specifically provided over the cover or an electrode protection layer beneath the cover.

The invention has been described in detail with particular reference to certain preferred embodiments thereof, but it will be understood that variations and modifications can be effected within the spirit and scope of the invention.

1. A flexible display, comprising:
at least one planar flexible substrate, at least one flexible light-emitting module deposited on the flexible substrate, the light-emitting module including at least one light-emitting layer, an anode, a cathode, and at least one top flexible superstrate on the opposite side of said display from said planar flexible substrate wherein the display is thermoelastically balanced in such a way that the display is always substantially flat, and the stress in at least one layer of the light-emitting module is substantially zero throughout the operating temperature range.

2. The flexible display of claim 1, wherein the light-emitting layer is an organic light-emitting diode.

3. The flexible display of claim 1, wherein at least one of said substrate or at least one of said superstrate has a thickness of between 0.1 mm and 4 mm.

4. The flexible display of claim 1, wherein at least one of said substrate or at least one of said superstrate comprises a polymer layer, a glass layer, or a metal layer.

5. The flexible display of claim 1 wherein said light-emitting layer has a thickness of between 0.1 and 20 micrometers.

6. The flexible display of claim 1 wherein the stress in said light-emitting layer is substantially zero.

7. The flexible display of claim 1 wherein said operating temperature is between 15 and 80° C.

8. The flexible display of claim 2 wherein the stress in said organic light-emitting diode is substantially zero.

9. The flexible display of claim 1 wherein the stress in the anode layer is substantially zero.

10. The flexible display of claim 1 wherein said anode layer comprises indium tin oxide.

11. The flexible display of claim 1 wherein said substrate or superstrate comprises polyethyleneterephthalate.

12. The flexible display of claim 1 wherein said substrate or superstrate is selected from the group consisting of polyolefin, polyamide, polystyrene, and polyurethane.

13. The flexible display of claim 1 wherein said substrate comprises a transmissive layer and a reflective or light absorbing layer.

14. The flexible display of claim 1 wherein said superstrate comprises a transmissive layer.

15. The flexible display of claim 1 wherein said substrate comprises aluminum foil.

16. The flexible display of claim 1 wherein said superstrate comprises co-extruded polymeric film layers.

17. The flexible display of claim 1 wherein the stress in said light-emitting layer is less than 10% of the ultimate strength said light-emitting layer.

18. A method of providing flexible display comprising at least one planar flexible substrate, at least one flexible light-emitting module deposited on the flexible substrate, the light-emitting module including at least one light-emitting layer, an anode, a cathode, and at least one top flexible superstrate on the opposite side of said display from said planar flexible substrate, wherein the method comprises
determining the steady state operating temperature of the display,
selecting the materials for each layer with their thickness, Young's moduli, Poisson's ratios, coefficients of thermal expansion so that Equations (11) and (12) are satisfied, thereby the display is thermoelastically balanced in such a way that the display is always substantially flat, and the stress in at least one layer of the light-emitting module is substantially zero throughout the operating temperature range, wherein Equation (11) is
$$\{ {[ A ]}^{- 1} [ B ] - {[ B ]}^{- 1} [ D ] \} \{ {[ A ]}^{- 1} \{ \begin{matrix}{N}_{x}^{T} \\ {N}_{y}^{T} \\ {N}_{xy}^{T}\end{matrix} \} - {[ B ]}^{- 1} \{ \begin{matrix}{M}_{x}^{T} \\ {M}_{y}^{T} \\ {M}_{xy}^{T}\end{matrix} \} \} = \{ \begin{matrix}0 \\ 0 \\ 0\end{matrix} \}$$
wherein Equation (12) is
$${\{ {[ B ]}^{- 1} [ A ] - {[ D ]}^{- 1} [ B ] \}}^{- 1} \{ {[ B ]}^{- 1} \{ \begin{matrix}{N}_{x}^{T} \\ {N}_{y}^{T} \\ {N}_{xy}^{T}\end{matrix} \} - {[ D ]}^{- 1} \{ \begin{matrix}{M}_{x}^{T} \\ {M}_{y}^{T} \\ {M}_{xy}^{T}\end{matrix} \} \} = Δ T {\{ \begin{matrix}{α}_{x} \\ {α}_{y} \\ {α}_{xy}\end{matrix} \}}_{j}$$

19. The method claim in claim 18 wherein the light-emitting layer is an organic light-emitting diode.

20. The method claim in claim 18 wherein said anode comprises indium tin oxide.
